(19) United States
(12) Patent Application Publication
(10) Pub. No.: US 2018/0349677 A1
(43) Pub. Date: Dec. 6, 2018

(54) VELOCITY-BASED ONLINE SIGNATURE VERIFICATION SYSTEM AND METHOD

(71) Applicant: EFFAT UNIVERSITY, JEDDAH (SA)

(72) Inventor: MOHAMMED ASMATULLAH KHAN, JEDDAH (SA)

(21) Appl. No.: 15/615,009

(22) Filed: Jun. 6, 2017

(51) Int. Cl. G06K 9/00

(52) U.S. Cl. CPC G06K 9/00181; G06F 21/31; G06K 9/00174; G06K 9/00194

(57) ABSTRACT

A method of calculating the authenticity of a signature acquired online from a touch sensitive computer display within a mobile or stationary device comprises comparing extracted strokes from a second signature to those of a known genuine signature to determine the degree of matching. The strokes are obtained by decomposing the velocity image of each signature into low medium, and high velocity portions; decomposing the medium velocity portion into two partitions; and extracting strokes from each partition into contiguous parts.

### BACKGROUND OF THE INVENTION

This invention relates to the field of computerized methods for on-line signature verification using pressure-sensitive displays on mobile devices such as smartphones, tablets, and stationary devices such as laptops or desktop computers.

The art of signature verification is a pattern recognition task for discriminating two classes: originals and forgeries. It is known that the signing process does not always result in identical signatures, and thus design of a signature verification system is largely related to the allowance of certain variabilities within the genuine class, while simultaneously rejecting forgery. Online signature verification systems use time-evolution of signatures, obtained with pressure sensitive displays such as tablets and are used in real-time applications such a credit card transactions or resource access.

Signature verification systems can be broadly categorized into two main classes: Offline Signature Verification and Online Signature Verification. Offline signature verification systems provide verification on the basis of shape characteristics and are useful in automatic verification of signatures found on bank checks and documents. In contrast, online signature verification systems use time-evolution of signatures that are captured by pressure sensitive tablets and could be used in real-time applications like credit card transaction or resource access. Online signatures are more robust to forgery problems than their counterpart, offline signatures, because they involve dynamic characteristics like velocity, pressure, etc. in addition to the morphological characteristics like shape. Two types of methodologies exist for online signature verification: parametric and functional. In the parametric approach, only global features are employed, which have the advantage that they cannot be affected by the local temporal shift. Though global feature processing has the advantage of being very fast and immune to local shifts, the error rates are generally high. One possible explanation for high error rate may be the large variation within the genuine class. In literature, several hundred parameters have been proposed for signature verification. Some of them are obtained from the time-function of the signature, and are therefore specifically devoted to online signature verification. The average, root mean square, the maximum and the minimum values are generally derived for the position, displacement, speed, and acceleration time-functions representative of a signature. Other parameters are determined as coefficients obtained from mathematical transforms. Fourier-, Hadamard-, and Wavelet-Transforms have been proposed for online and offline signature verification, The typical parameters for online verification also include, in some cases, the signature acquisition process, total signature time duration, pen-down time ratio, or number of pen lifts.

On the other hand, the functional approaches represent the signature signal as a function of time and compare the similarity by accumulating the difference between two functions in time. In general, it has been accepted that a functional approach allows better performance than parametric approaches but functional approaches usually require time-consuming procedures. Velocity, acceleration, direction of pen movement, pressure, forces, and position are generally used as functional features. Among them, velocity is generally considered to be more informative than position and acceleration for online signature verification. Using the functional approach which is otherwise superior of accuracy, to date the implementation time has been too long which has prevented widespread adoption of such an approach.

### SUMMARY OF THE INVENTION

We have discovered a functional approach to online signature verification which uses computer resources more efficiently and reduces implementation times. The present invention employs a stroke-based signature verification method which breaks acquired signatures into the number of letters based on their dynamic features, and verification is performed on the basis of letter-by-letter comparison. This leads to parallelism in signature verification process and provides more efficient solution. According to this invention, strokes are obtained by decomposing the velocity profile of a signature into low, medium, and high velocities. Low- and high-velocity portions of a signature are disregarded and only the medium-velocity portion is used for its verification process, saving computer resources and reducing implementation time.

In one aspect the invention comprises A method of calculating the authenticity of a signature acquired online from a touch sensitive computer display within a mobile or stationary device comprising the steps of: obtaining the velocity image of a genuine signature acquired online from the touch sensitive display; decomposing the velocity image of the genuine signature into low medium, and high velocity portions; decomposing the medium velocity portion into two partitions; extracting strokes from each partition into contiguous parts; storing the extracted strokes from the genuine signature in a database; obtaining the velocity image of a second signature whose authenticity is unknown; decomposing the velocity image of the second signature into low, medium, and high velocity partitions; decomposing the medium velocity portion of the second signature into two partitions; extracting strokes from the each partition of the second signature into contiguous parts; comparing the extracted strokes from each partition of the second signature to the extracted strokes of the genuine signature to determine a numerical degree of matching; if the numerical degree of matching is above a predetermined amount, signaling that the second signature is genuine; otherwise signaling that the second signature is a forgery.

In some embodiments a histogram of the velocity profile is erected. Then the region between mean+standard deviation and mean−standard deviation is declared as medium velocity and used for subsequent comparison.

The genuine signature and the second unverified signature are acquired from the touch sensitive display which relays the shape of the signature as well as its velocity profile information to a computer programmed with the algorithm of the invention. Next, the shape of the signature is smoothed and resized to a standard format. Then using its associated velocity profile, stable strokes are extracted and compared with strokes of genuine signatures in a database to make a subsequent decision.

### BRIEF DESCRIPTION OF THE DRAWINGS

FIG. 1(a) is a sample signature to be verified.

FIG. 1(b) is a set of strokes of a sample signature extracted using a first partition in medium velocity.

FIG. 1(c) is a set of strokes extracted using a second pardon in medium velocity.

FIG. 1(d) is a set of strokes of the sample signature using the local minima method.

FIG. 2 is a flow chart of an on-line signature verification system of the invention.

FIG. 3 is a flow chart with output examples illustrated.

FIG. 4 is a histogram of a velocity profile which resembles a Gaussian distribution, wherein the medium region is obtained as the region between mean+standard deviation and mean−standard deviation.

FIG. 5 is a graph of the partitioning of the velocity profile of a given signature in the three regions as determined by the histogram of FIG. 4.

### DETAILED DESCRIPTION

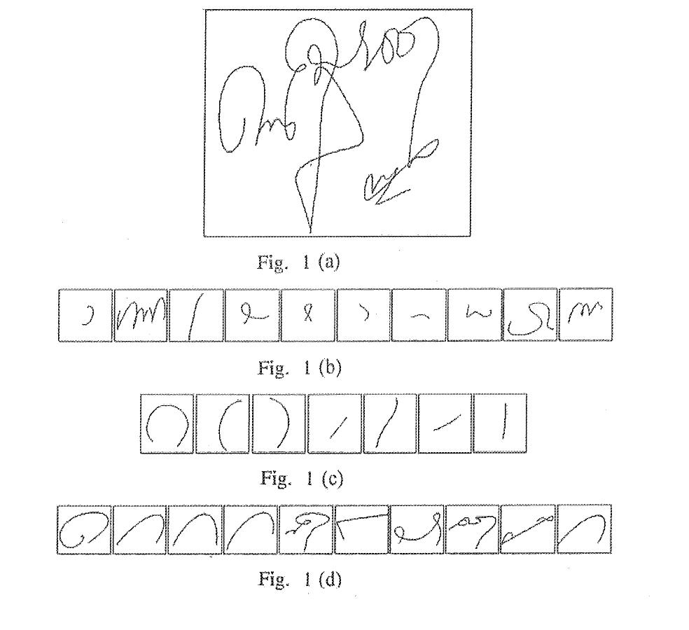

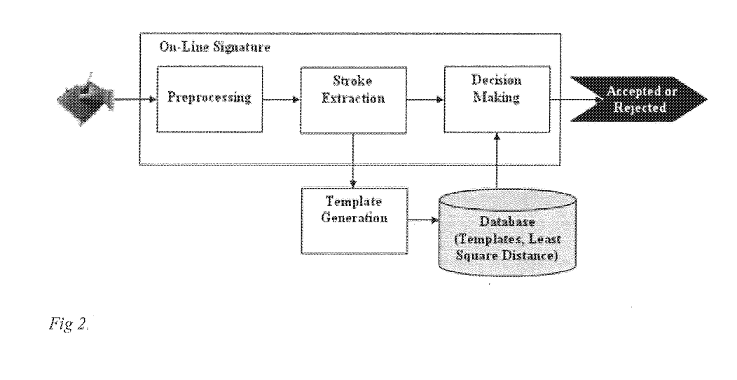

As mentioned above, using the functional approach which is otherwise superior of accuracy, to date the implementation time has been too long which has prevented widespread adoption of such an approach, A remedy to this problem is possible by involving less-complicated and smaller strokes which are either linear or, at the most, having a single loop. Strokes extracted from a signature according to the method of this invention are simple enough that each stroke is comprised of only straight lines and small curves. As strokes are smaller and local in nature, they are less vulnerable to intrapersonal variations. Strokes are obtained by decomposing the velocity profile of each signature into low, medium, and high velocities. Low- and high-velocity portions of a signature are disregarded for their precarious stability among the genuine class, and the medium-velocity portion is decomposed into two more partitions, referred to as velocity images. Further, in each velocity image, the strokes are extracted as contiguous parts. As an example, one signature and its corresponding strokes obtained in this fashion are shown in FIGS. 1(a) 1(d). It can be observed that strokes are simple and local in nature so that our subsequent template-generation process is speedy and less stressful. The resulting template is found by empirical experiments to provide improved discrimination result.

In the method of the invention, strokes are extracted on the basis of partitions created in base-velocity profiles. Compared to prior processes, this method allows better exploitation of inter-dependencies between velocity and shape signals by employing multiple velocity bands and extracting simple strokes of a given signer where a forger will have hard time in maintaining shape within a certain velocity band.

Compared to prior methods, in the present method only the medium part of the velocity information is exclusively used for verification purposes. Other methods use a composite feature set including velocity, pressure, acceleration, pen angle, and other features. The present invention uses only one feature for matching, stroke velocity.

Referring now to the drawings, FIG. 1(a) is a sample signature to be verified.

FIG. 1(b) is a set of strokes of a sample signature extracted using a first partition in medium velocity

FIG. 1(c) is a set of strokes extracted using a second partion in medium velocity.

FIG. 1(d) is a set of strokes of the sample signature using the local minima method.

FIG. 2 is a flow chart of an on-line signature verification system of the invention. FIG. 2 shows the block diagram of the proposed scheme, where a signature is put on a tablet that relays the shape of the signature as well as its velocity profile information to the computer. Next, the shape of the signature is smoothed and resized to a standard format. Then using its associated velocity profile, stable strokes are extracted and compared with already existing database to make a subsequent decision.

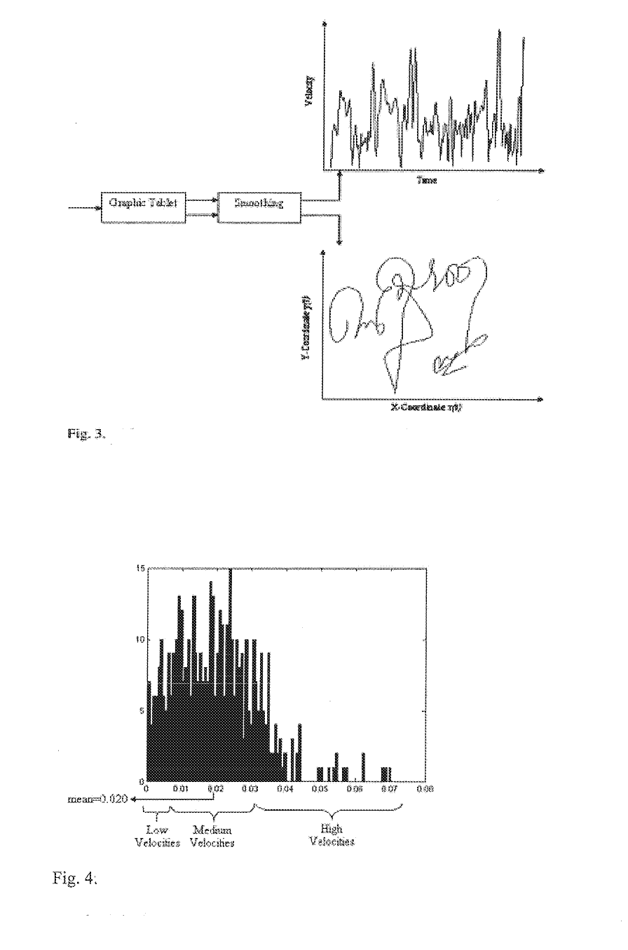

FIG. 3 is a flow chart with output examples illustrated. After smoothing, two outputs are obtained, one being the velocity and the other the shape. Velocity is denoted by v and shape is described by x and y coordinates. All three variables are interconnected with each other through a single variable, t, (time).

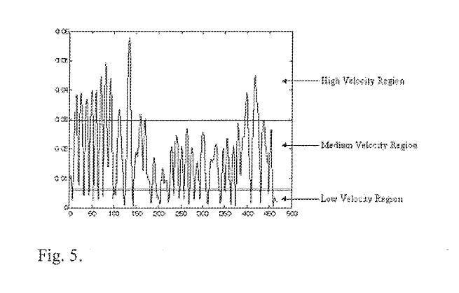

FIG. 4 is a histogram of a velocity profile which resembles a Gaussian distribution, wherein the medium region is obtained as the region between mean+standard deviation and mean−standard deviation.

FIG. 5 is a graph of the partitioning of the velocity profile of a given signature in the three regions as determined by the histogram of FIG. 4.

We have discovered that velocity alone is stable enough feature for verification purposes and provides comparable results to the composite feature set used in earlier methods. The velocity and shape parts of the signature are displayed in FIG. 3.

An important difference from prior online methods is that instead of using a velocity feature as a whole, it obtains a stable region within the complete velocity profile of the signer. The method partitions base velocity into three partitions: low, medium, and high based on their statistical nature as Gaussian distribution. We have discovered that the medium region of the velocity profile is the most stable region for a given signer and provides the highest discrimination score while comparing with other fake signatures.

Using instantaneous velocity profile of a signer, and then finding the most stable middle region of this velocity profile are distinguishing characteristics of the online signature model as compared to already proposed methods.

The present invention, therefore, is well adapted to carry out the objectives and attain the ends and advantages mentioned, as well as others inherent therein. While the invention has been depicted and described and is defined by reference to particular embodiments of the invention, such references do not imply a limitation on the invention, and no such limitation is to be inferred. Consequently, the invention is intended to be limited only by the spirit and scope of the appended claims, giving full cognizance to equivalents in all respects.

What is claimed is:

1. A method of calculating the authenticity of a signature acquired online from a touch sensitive computer display within a mobile or stationary device comprising the steps of:
a. obtaining the velocity image of a genuine signature acquired online from the touch sensitive display;
b. decomposing the velocity image of the genuine signature into low medium, and high velocity portions;
c. decomposing the medium velocity portion into two partitions;
d. extracting strokes from each partition into contiguous parts;
e. storing the extracted strokes from the genuine signature in a database;
a. obtaining the velocity image of a second signature whose authenticity is unknown;
b. decomposing the velocity image of the second signature into low, medium, and high velocity partitions;
c. decomposing the medium velocity portion of the second signature into two partitions;
d. extracting strokes from each partition of the second signature into contiguous parts;
e. comparing the extracted strokes from each partition of the second signature to the extracted strokes of the genuine signature to determine a numerical degree of matching;
f. if the numerical degree of matching is above a predetermined amount, signaling that the second signature is genuine; otherwise signaling that the second signature is a forgery.
